(19) United States
(12) Patent Application Publication
(10) Pub. No.: US 2004/0006511 A1
(43) Pub. Date: Jan. 8, 2004

(54) Methods and sytem for a distributed transaction control system in enhanced directory assistance services

(75) Inventor: William A. Montemer, Long Beach, CA (US)

Correspondence Address: William A. Montemer, Suite 120, 24422 Avenida de la Carlota, Laguna Hills, CA, 92653, US

(73) Assignee: INTERCHANGE CORP.

(21) Appl. No.: 10/612,772

(22) Filed: Jul. 2, 2003

Related U.S. Application Data
(60) Provisional application No. 60/393,837, filed on Jul. 8, 2002.

(51) Int. Cl. G06F 17/60

(52) U.S. Cl. 705/14; 705/1

(57) ABSTRACT

Directory assistance provides telephone number look up services to callers based on the business or caller name as listed in a telephone directory. In the prior art, directory assistance provides a value-added service to telephone users and an expense that must be charged back to telephone users or absorbed by telephone carriers. In enhanced directory assistance (EDA) services as described in the disclosure, EDA is further developed to deliver a keyword targeted advertising service to telephone listing owners and advertisers. The present invention provides a method and system for handling the additional business processes and requirements necessary for performing distributed financial transactions. A further object of the invention is to provide methods and systems to support complex, flexible and dynamic business relationships in said EDA service.

### RELATED APPLICATION INFORMATION

This application claims priority from U.S. Provisional Patent Application No. 60/393,837 filed Jul. 3, 2002 and which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGR UND OF THE INVENTION

1. Field of the Invention

The present invention relates to the field of telecommunications, and particularly to providing advertising opportunities in directory assistance systems.

2. Description of the Related Art

Telephone Directory Assistance has been around as long as there have been telephone operators. Once the number of telephone subscribers reached two and three digits, telephone directories were published as service to the large numbers of telephone subscribers. These published telephone directories or books helped both the subscribers and telephone operators locate and contact other telephone subscribers.

There are two types of telephone directories. The White Page-styled directory lists basic telephone contact information for all telephone subscribers; basic listings are free to all subscribers and subscribers are listed by name. The Yellow Page-styled directory lists products and services by category, to be included in a Yellow Page directory an advertiser must pay a fee. The Yellow Page directory advertiser pays for both the size of the advertisement or listing and for its inclusion in one or more specific categories.

Traditional directory assistance service provides telephone number look up to the White Page style directory. Enhanced directory assistance service provides look up to a Yellow Page style directory. The difference between the two is based on how a caller finds a particular directory listing.

In a traditional directory assistance service, the caller contacts a directory assistance operator and gives the operator the name of a business or person and its associated locale. The directory assistance operator then searches a telephone directory database for a telephone listing that matches the sought-after criteria. Upon finding a match or a set of matches, the operator informs the caller and either gets further information to narrow the results or offers to connect the caller to a desired telephone number.

In an enhanced directory assistance system, a caller contacts a directory assistance operator and in addition to providing as some localization information to narrow where the caller wishes to find the product or services, the caller provides a category name or keyword associated with the desired product or service. In the present art, an enhanced directory assistance operator then takes the provided information and searches or queries a Yellow Page-styled directory. Upon finding a match, the operator informs the caller and either gets further information to narrow the results or offers to connect the caller to the desired telephone number.

In the present art, inclusion in these paid listings is offered to a business or organization through monthly or yearly subscription fees. Also in the present art, listing partners can pay a premium fee to be listed at the top of a category or keyword lookup result list. The premium or preferred listing is given priority treatment by the directory assistance operator and mentioned before any other paid listings are communicated.

The yellow pages business model in the present art is built on a publishing model used by book and newspaper publishers. In this model, an advertiser pays a yearly fee for an advertisement to appear. The directory is reprinted yearly so the advertiser is charged again with each printing.

The enhanced directory assistance model is of a real time, “always available” model. The advertisements can be dynamic and changed an unlimited number of times as the advertiser fancies. Also, in the present art, there are multiple yellow page publishers, each with their own set of local advertising clients. Rather than competing outright with one publisher competing against another advertiser for the same client, the EDA business model implements revenue sharing, where competing publishers pool the advertising resources and share the referral revenue.

The present invention discloses systems and method that support and encourage cooperative real time business models such as this.

### BRIEF DESCRIPTI N OF THE DRAWINGS

FIG. 1 shows a system block diagram of an Enhanced Directory Assistance (EDA) Listing Service.

FIG. 2 shows an operation sequence diagram for an EDA Listing Service.

FIG. 3 shows a conceptual view of an EDA Referral Packet.

FIG. 4 shows an embodiment of an EDA Advertiser Directory Listing (ADL) database.

FIG. 5 details a Get Listing Results operation on an EDA ADL database.

FIG. 6 shows a system block diagram of a multi-platform EDA Listing delivery system.

FIG. 7 shows a system block diagram of multiple asynchronous EDA business processes involved in a paid referral business transaction.

FIG. 8 shows a conceptual view of the repackaging of EDA business transactions.

FIG. 9 shows a system block diagram of orchestrating several distributed EDA business processes.

### DETAILED DESCRIPTION OF THE INVENTION

Enhanced Directory Assistance Listing Service

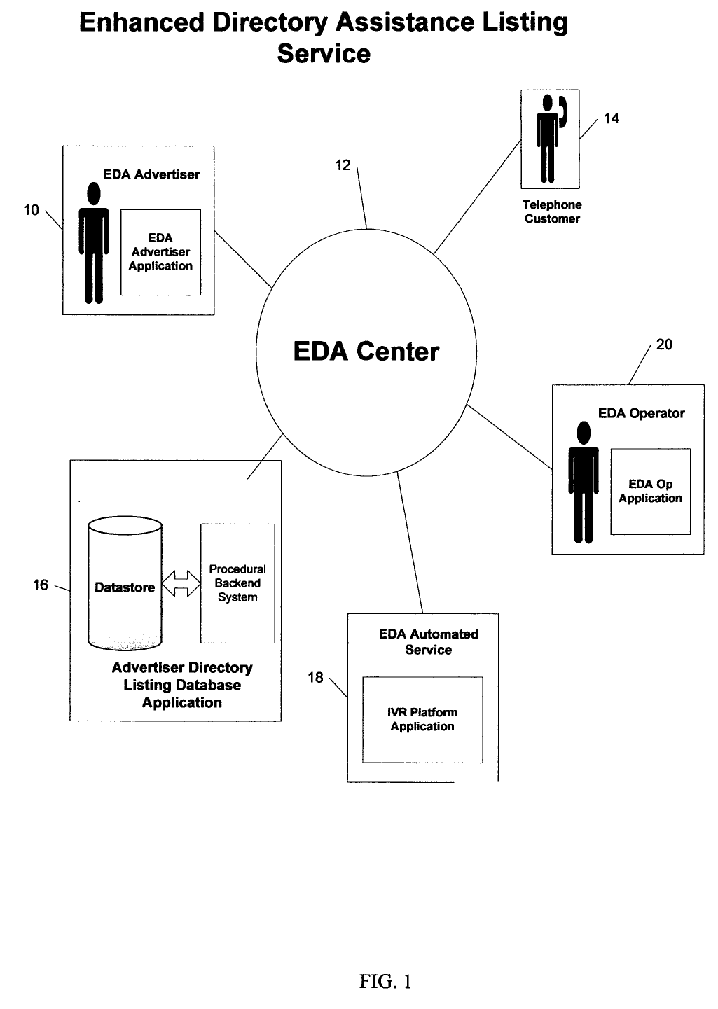

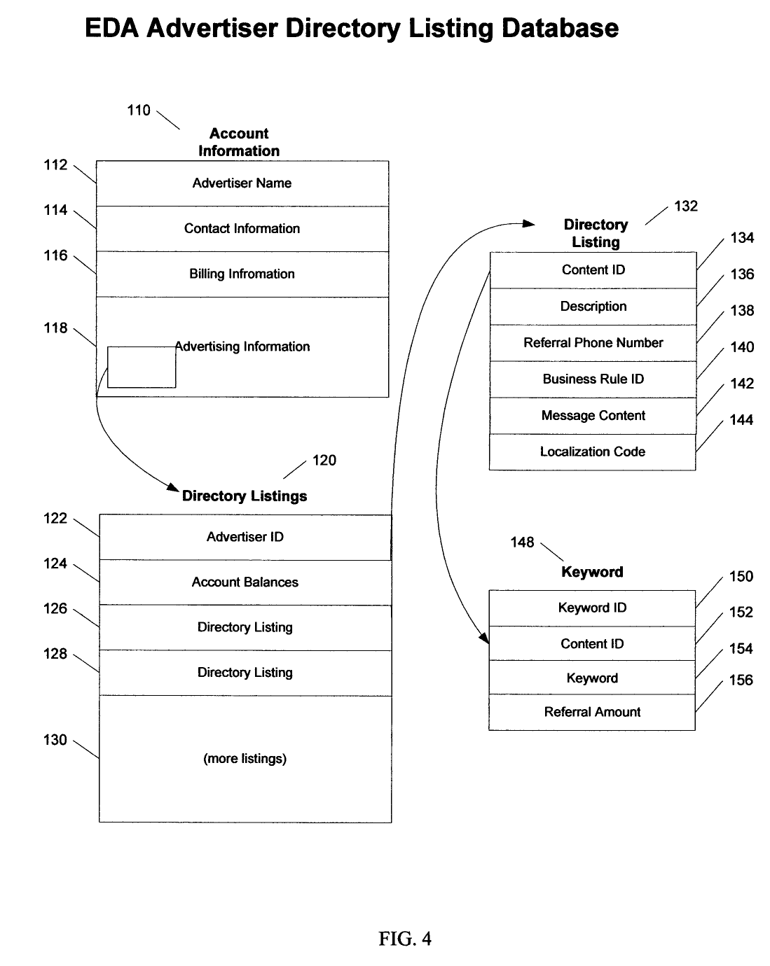

Enhanced Directory Assistance (EDA) services provide opportunities for telephone listing owners and advertisers to promote their products and services to telephone callers looking for the same products and services. In reference to FIG. 1, the illustration shows such an EDA Listing Service. In the embodiment, an EDA Advertiser 10 owns a set of telephone directory listings that are maintained in the EDA Center 12, in an Advertiser Directory Listing (ADL) Database 16. As will be detailed in FIG. 4, each directory listing is associated with one or more keywords.

The operation of the EDA Listing Service is straightforward. The EDA Advertiser agrees to pay the EDA Center provider a predetermined amount of money for every telephone referral the advertiser receives from the EDA Center. The EDA service discussed here can rightly be called a paid referral service.

When a Telephone Customer 14 dials a predetermined EDA number, the EDA Center assigns the call to an EDA Operator 20. After determining the geographical location of the customer, the operator obtains a keyword from the customer, thereby identifying the product the customer is seeking.

The operator then submits the keyword to the ADL database application. The ADL application returns a list of advertised telephone listings for the particular keyword submitted. The individual referrals can be organized in any number of ways. In one embodiment, the referral list is organized by the highest to lowest amount paid for each referral. In this embodiment the EDA operator recites the list to the customer, who selects one of the referral items.

In another EDA Listing Service embodiment, the functions of the EDA Operator can be done by an Interactive Voice Response (IVR) system. In an IVR embodiment a series of voice dialogs could be constructed using any number of well-known Voice XML (VXML) platforms. The IVR system creates a vocal menu from the set of referrals returned by the ADL application and the customer selects one.

The final result of an EDA inquiry is a telephone referral. In the referral, the customer's telephone call is transferred to the selected advertised directory listing referral number and a referral business transaction is initiated. The directory listing referral number is but a small part of the data involved in a paid EDA referral. This disclosure covers the other data involved in the paid referral, and how it is communicated and processed.

EDA Operation Sequence Diagram

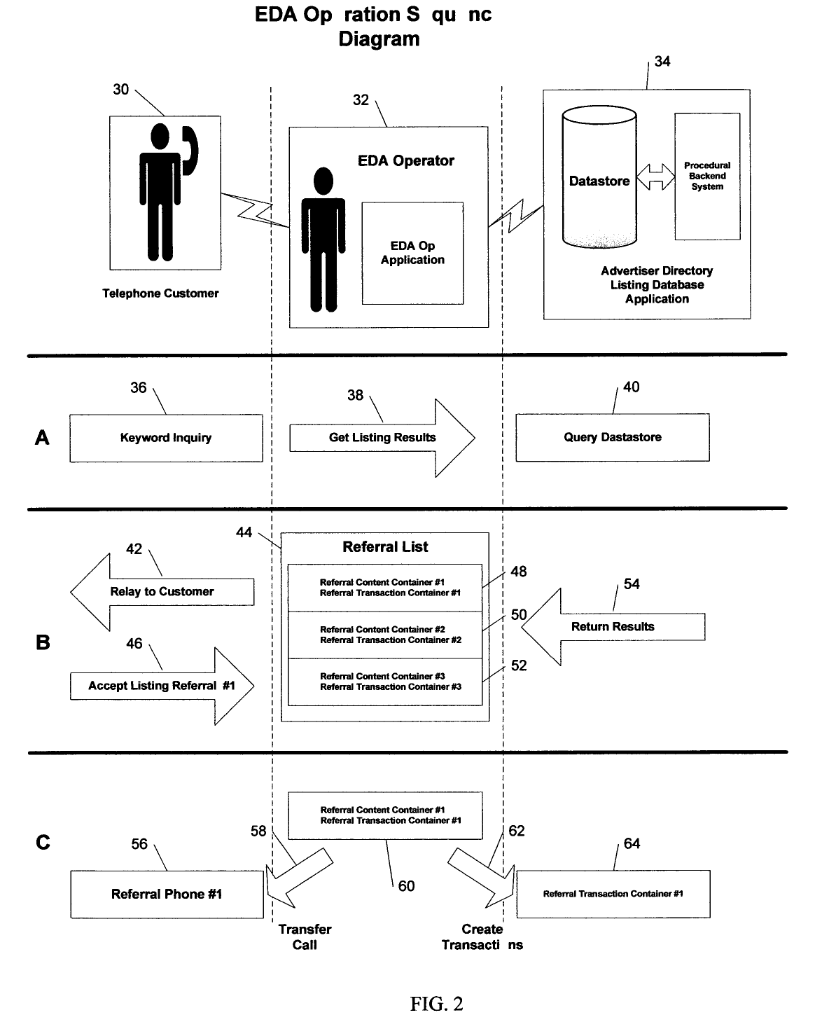

FIG. 2 shows the sequence of operations that occur in a paid referral. Referring to FIG. 2, the Telephone Customer 30 looking for a product or service is connected to an EDA Operator 32 who queries the Advertiser Directory Listing Database 34 (ADL).

In sequence A, the customer relays a Keyword Inquiry 36 that describes the sought-after product or service to the EDA operator. The operator Gets Listing Results 38 by running a Keyword Query 40 on the ADL data store.

According to sequence B, the ADL Returns Results 54 to the operator in the form of a Referral List 44. The list consists of three referral packets or sets of referral data 48, 50, and 52. Each referral consists of two kinds of data: a Referral Content Container (RCC) consisting of information about the listing and a Referral Transaction Container (RTC) made up of business data associated with the listing. The operator relays the set of referrals to the customer 42 who selects one and Accepts a Listing Referral 46.

Finally in sequence C, the operator Transfers the Call 58 to the selected Referral Number 56 and Initiates paid referral business transactions 62 by passing the Referral Transaction Container 64 to the EDA business process. The RTC encapsulates all the information necessary to process a paid referral business transaction.

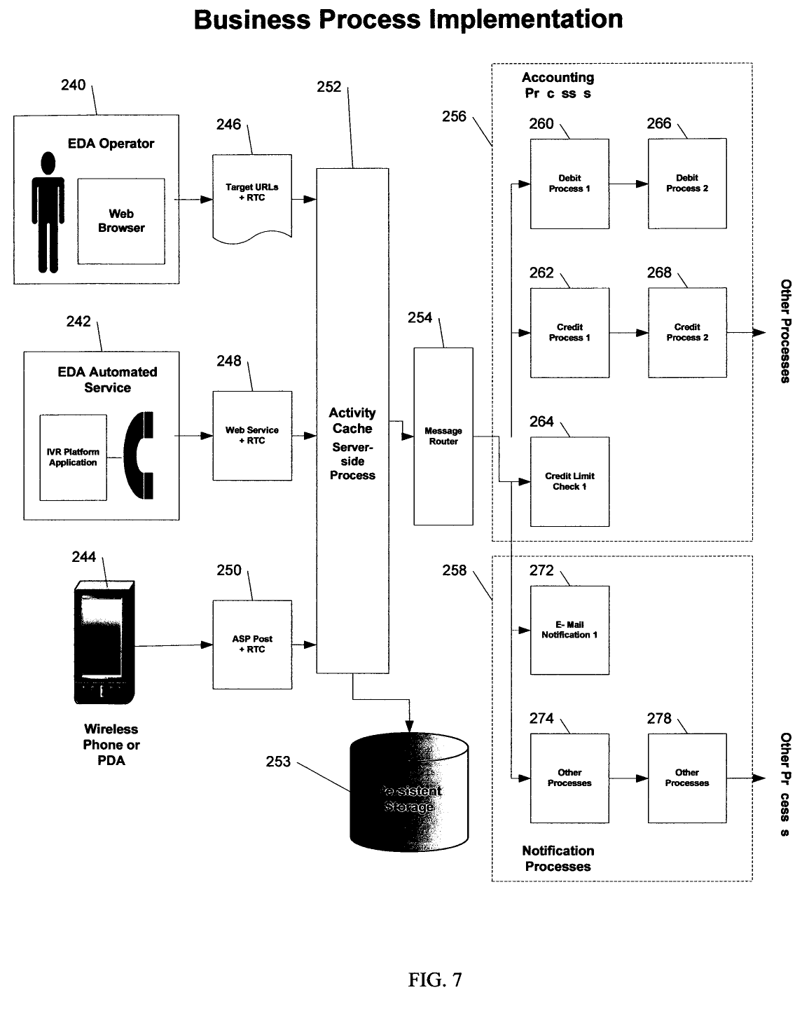

A paid referral business transaction—detailed in FIG. 7—is a consistent change in the state of the paid referral business system. The transaction is driven by a well-defined business function of that system. In sequence C, the business function is the referral of a customer to an advertised listing. The EDA system takes the RTC information and uses it to run a series of debit and credit transactions.

EDA Referral Packet

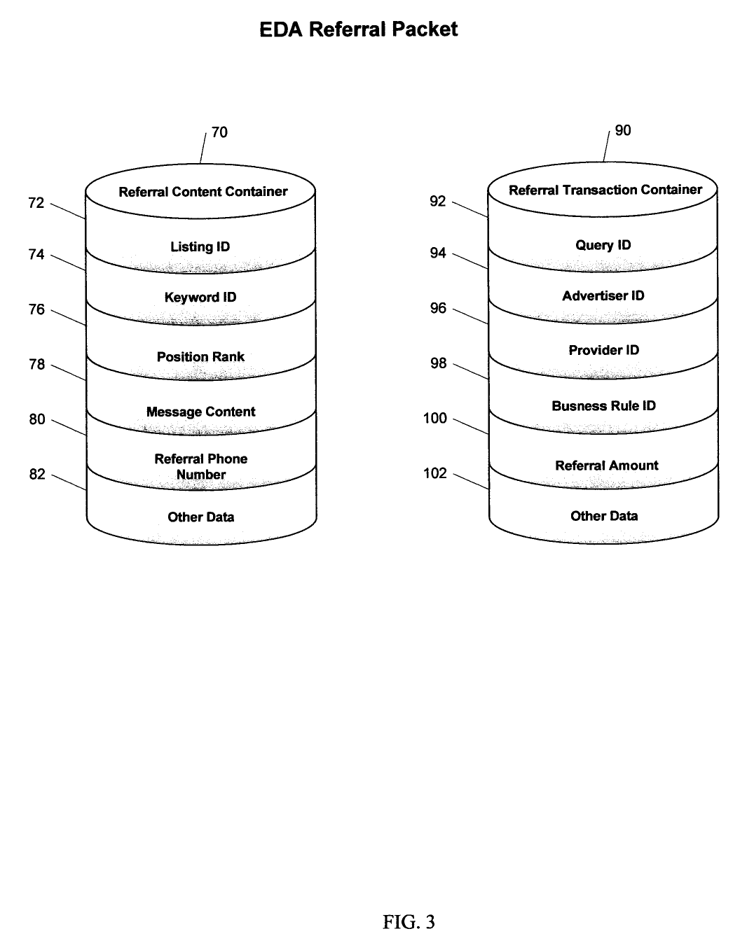

FIG. 3 illustrates what makes up an EDA Referral packet. In a preferred embodiment, an EDA Referral packet is composed of referral content data and referral business process data. The content is encapsulated in the Referral Content Container (RCC) and the business data is encapsulated in the Referral Transaction Container (RTC)

The Referral Content Container 70 consists of data and metadata (descriptive data about data) about a specific directory listing. This data includes:

a Listing ID 72 that uniquely identifies the listing;

a Keyword ID 74 that uniquely identifies the keyword;

a Position Rank 76 that specifies where the listing is positioned in the result list;

the Message Content 78 that is read or played back to the customer;

the Referral Phone Number 80 that the call is transferred to;

a Query ID 81 that uniquely identifies the EDA inquiry;

other data 82 that may be used in this embodiment.

A Referral Transaction Container 90 encapsulates all the data needed to process an EDA referral transaction. The RTC includes:

a Query ID 92 that uniquely identifies the EDA inquiry;

an Advertiser ID 94 that uniquely identifies the listing owner;

a Provider ID 96 that uniquely identifies the entity that owns or operates the EDA service;

a Business Rule ID 98 that uniquely identifies the collection of business rules that govern the paid referral transaction;

a Referral Amount 100 that the advertiser pays for a referral;

other data 102 that may be used in this embodiment.

All the data contained in an EDA Referral packet is taken from the Advertiser Directory Listing (ADL) database, which is detailed in FIG. 4—a system block diagram of the EDA Listing Database.

Advertiser Directory Listing Database

Referring to FIG. 4, the ADL database contains a collection of database tables that are serviced by a database engine. The database of the preferred embodiment contains an Account Information 110 table. The Account Information table contains information about EDA listing owners, business partners and Listing advertisers. The information contained in the table includes Advertiser Names 112, Contact Information 114 such as telephone numbers, and Billing Information 116.

The table also includes links to detailed Advertising Information 118. Included in the embodiment is a link to a set of Directory Listings. In a preferred embodiment, the table of Directory Listings 120 includes of a unique identifying advertiser ID 122, Account Balance entries 124, and one or a plurality of individual directory listings pointers 126, 128, 130.

In a preferred embodiment, each Directory Listing is linked to an individual Directory Listing 132 table. Each record of the Directory Listing table contains:

Content ID 134 that uniquely identifies the listing;

Description 136;

Referral Phone Number 138;

Business Rule ID 140 specifying the business process that applies to the listing;

the Message Content 142 that is read or played back;

Localization code 144 that identifies the effective locality or localities of the listing.

The Content ID in turn relates to a Keyword 148 table that identifies one or a plurality of keywords associated with the listing. The Keyword table includes:

a Keyword ID 150;

a Content ID 152 that points to a specific directory listing;

the actual Keyword associated with the listing;

a Referral Amount that will be paid by the advertiser for each referral.

There may be several other tables in the ADL database implementation that supports the business processes of the EDA service, such as transaction and accounting tables. Nevertheless, the identified tables provide enough information to support this disclosure.

Get Listing Results Operation

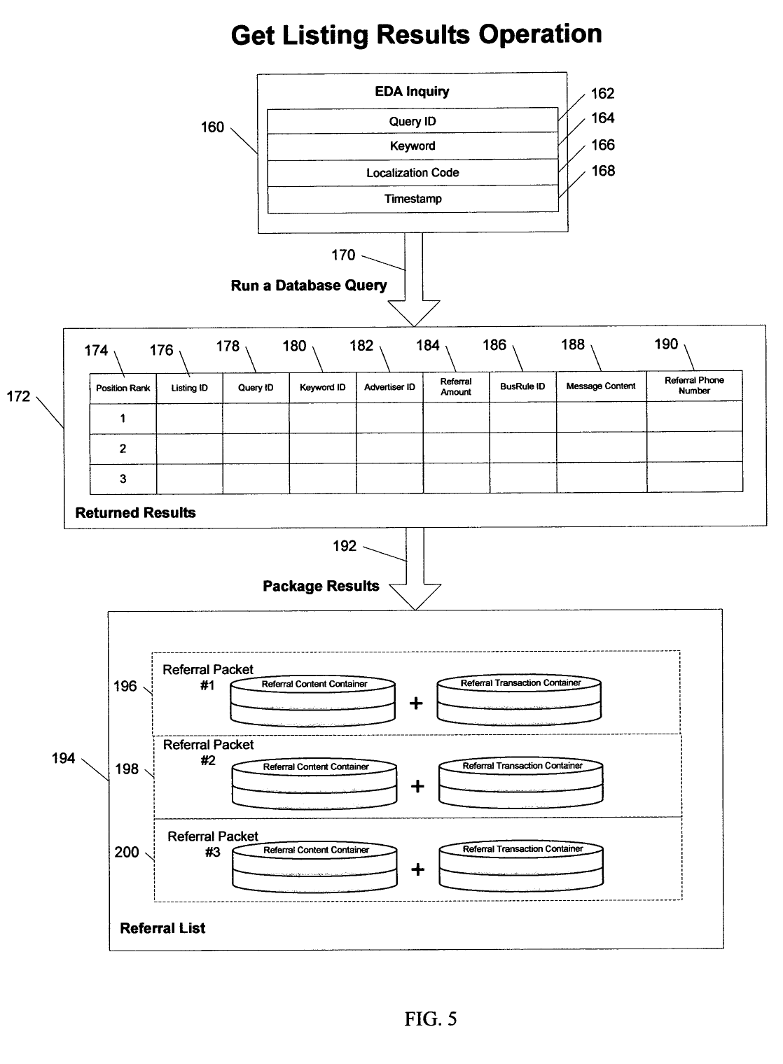

FIG. 5 details data involved in the Get Listing Results Operation. In reference to FIG. 5, the EDA Inquiry 160 contains a Query ID 162 that uniquely identifies this query, a Keyword 164 that is associated to the sought-after product or service, a Location Code 166 that identifies a geographical domain for the query and a Timestamp.

The EDA Inquiry data is then used to Run a Database Query 172 to generate a list of results that satisfy the EDA request. In a preferred embodiment, this data is used in a standard SQL query that is applied to a SQL database. In the embodiment, the Returned Results 172 form a row-column table, with rows representing individual referrals. The columns of the returned results include:

a Position Rank number 174 that specifies the order of the referral listing in the result set;

the Listing ID 176 that identifies this listing;

the Query ID 178 that identifies this query;

the Keyword ID 180 that identifies the keyword that generated this result set;

the Advertiser ID 182 that identifies the listing owner;

the Referral Amount that specifies the amount paid for a referral by this advertiser;

the Business Rule ID that is used to specify the business arrangements made with this advertiser;

the Message Content 188;

the Referral Phone Number 190.

The next step in embodiment of an EDA System involves Packaging the Results 194 into a Referral List 194. The referral packets 196, 198, 200 are enclosed in a single list that is then used by an EDA operator to make a referral.

In a preferred embodiment, the referral list is an XML document as detailed in the Listing 1. In one embodiment, the Referral List XML document is generated by a set of JAVA classes that generates the custom tags, attributes and values as shown in the listing.

The generation of XML documents from a database with JAVA object code is well known and well understood.

Listing 1. XML Representation

<Referral List>

<Referral Packet>

<Referral Content Container>

<ListingID value=some ListingID1 />
<KeywordID value=some KeywordID1 />
<PositionRank Value=1 />
<Message Content>This is message one.
</Message Content>
<Referral Phone>(123)555-1212</Referral Phone>

</Referral Content Container>
<Referral Transaction Container>

<QueryID value=some QueryID1 />
<AdvertiserID value=some AdvID1 />
<ProviderID value=some ProviderID0 />
<BusRuleID value=some BusRuleID1 />
<Referral Amount value=1.00 />

<Referral Transaction Container>

</Referral Packet>
<Referral Packet>

<Referral Content Container>

<ListingID value=some ListingID2 />
<KeywordID value=some KeywordID2 />
<PositionRank Value=2 />
<Message Content>This is message two.
</Message Content>
<Referral Phone>(123) 555-1234</Referral Phone>

</Referral Content Container>
<Referral Transaction Container>

<QueryID value=some QueryID2 />
<AdvertiserID value=some AdvID2 />
<ProviderID value=some ProviderID0 />
<BusRuleID value=some BusRuleID2 />
<Referral Amount value=0.80 />

</Referral Transaction Container>

</Referral Packet>
<Referral Packet>

<Referral Content Container>

<ListingID value=some ListingID3 />
<KeywordID value=some KeywordID3 />
<PositionRank Value=3 />
<Message Content>This is message three.
</Message Content>
<Referral Phone>(123) 555-4567</Referral Phone>

</Referral Content Container>

<Referral Transaction Container>

<QueryID value=some QueryID3 />
<AdvertiserID value=some AdvID3 />
<ProviderID value=some ProviderID0 />
<BusRuleID value=some BusRuleID3 />
<Referral Amount value=0.75 />

</Referral Transaction Container>

</Referral Packet>

</Referral List>

Multi-Platform Referral Packaging

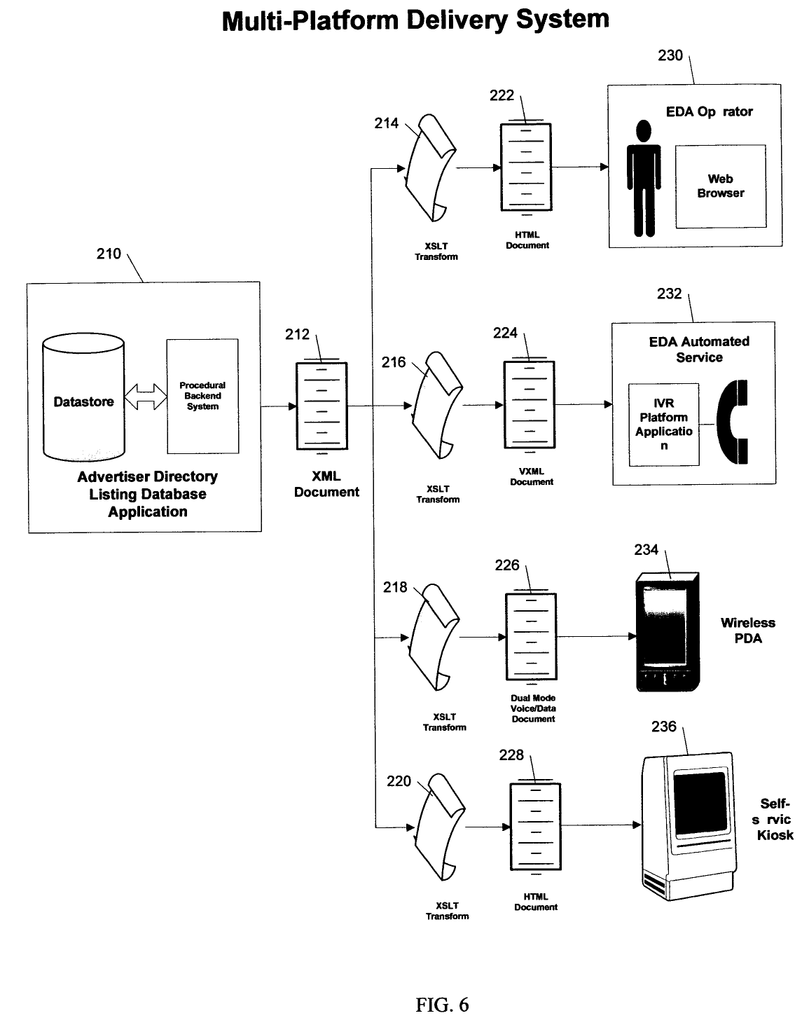

FIG. 6 illustrates an XML based delivery system for an EDA service. By delivering the referral list as an XML document, the disclosed EDA System enables the referral data to be easily used in multiple forms and on multiple platforms. In a preferred embodiment, the implementation supports multiple target platforms. Referring to FIG. 6, the Advertiser Directory Listing Database Application 210 generates an EDA Referral result as an XML document 212. The document is transformed for different delivery platforms by eXtensible Stylesheet Language Transform documents (XSLT).

EDA referral results can be delivered as HTML documents 220 and displayed as HTML linked text by browsers used by EDA operators. The EDA operator reads the HTML text to customers and initiates referral transactions by clicking on links.

In an EDA Automated Service embodiment 232, an XSLT document 218 transforms the referral list as a Voice XML 234 (VXML) document. An Interactive Voice Response (IVR) system creates voice menu dialogs on the fly and makes selections by interpreting the telephone customer's voice.

In a wireless Personal Digital Assistant (PDA) embodiment, the XSLT 218 transforms the referral list document into a dual mode voice/data document 226. The wireless PDA 234 interprets the page links, dials the referral number and initiates the referral transaction.

In a self-service Kiosk embodiment, the XSLT transforms the referral list into another HTML document that is delivered to a kiosk. EDA Customers can then make inquiries and accept referrals on their own.

RTC and Business Transactions

FIG. 7 illustrates a distributed business process for an EDA service. The business processes can be web enabled web services, proprietary legacy applications, or combined manual and automatic processes. These types of process can be exposed to an HTTP network using well-known, well-publicized technologies such Web Services, .NET, and Java.

A business transaction is a consistent change in the state of the business system. The transaction is driven by a well-defined business function of that system. In the paid referral business transaction as described in the EDA service, the business function is to refer a customer to an advertised listing.

Referring to FIG. 7, in one embodiment a referral business transaction is initiated by an EDA operator who clicks on a referral link in an HTML encoded referral list. The link passes RTC data to the target URL 246 as name-value pairs. In the Automated Service embodiment 242, the IVR platform recognizes voice input and passes the RTC data directly to business-to-business Web Services. In the Dual Mode Wireless Phone/PDA embodiment, client-side programs can http-post the RTC data directly to Active Server Page (ASP) pages 250.

In all of the illustrated embodiments, the transaction data is sent to various web-exposed input devices that are then connected to server-side processes. The transaction data is captured and processed by an Activity Cache 252, which is server-side processing code that checks, formats, and redirects the input data.

At this point the input data is saved to Persistent Storage 253 and sent to a Message Router 254 process. The data that is routed consists of the RTC data that is placed within a “message envelope”. This envelope is addressed to assorted target business processes, for instance Accounting Processes 256 or Notification Processes 258.

The targeted backend processes can be stand alone as the Credit Limit Check 1 264 process or the E-Mail Notification 1 272 process or hierarchical multi-step processes such as Debit Process 1 & 2 260, 266 or Credit Process 1 & 2 262, 268 or any number of daisy-chained processes 274, 278.

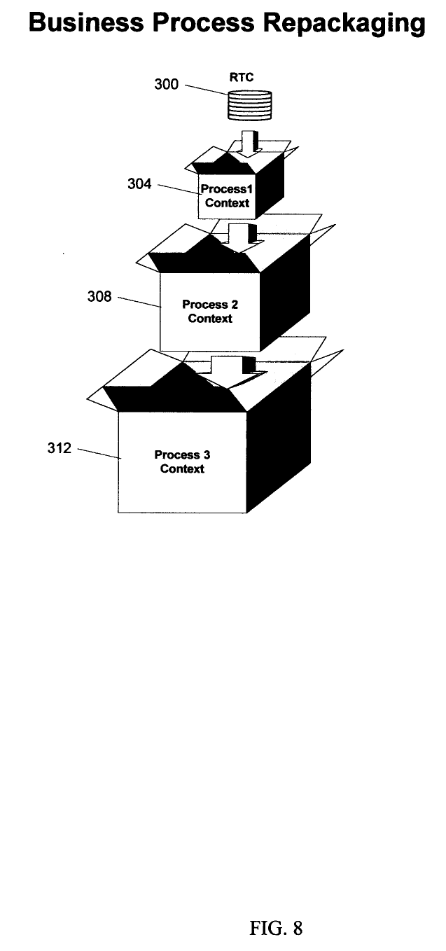

In each of the disclosed implementations, the transaction data is encapsulated as a package, processed, repackaged and sent to another processing step. As illustrated in FIG. 8, the repackaging at each step adds the processing context to the resulting package.

Referring to FIG. 8, in one embodiment the referral transaction container or RTC package 300 that contains the initial transaction data is processed in Process1 and packaged with the Process1 Context 304 data. This packaged is delivered and processed in Process2 and repackaged with the Process2 Context data. Finally, this package is processed in Process3 and repackaged again with the Process3 Context data.

This simple method of successively packaging the process context in a transaction package creates a robust method that efficiently tracks the progress of a multilevel business process.

Distributed Business Process Orchestrati n

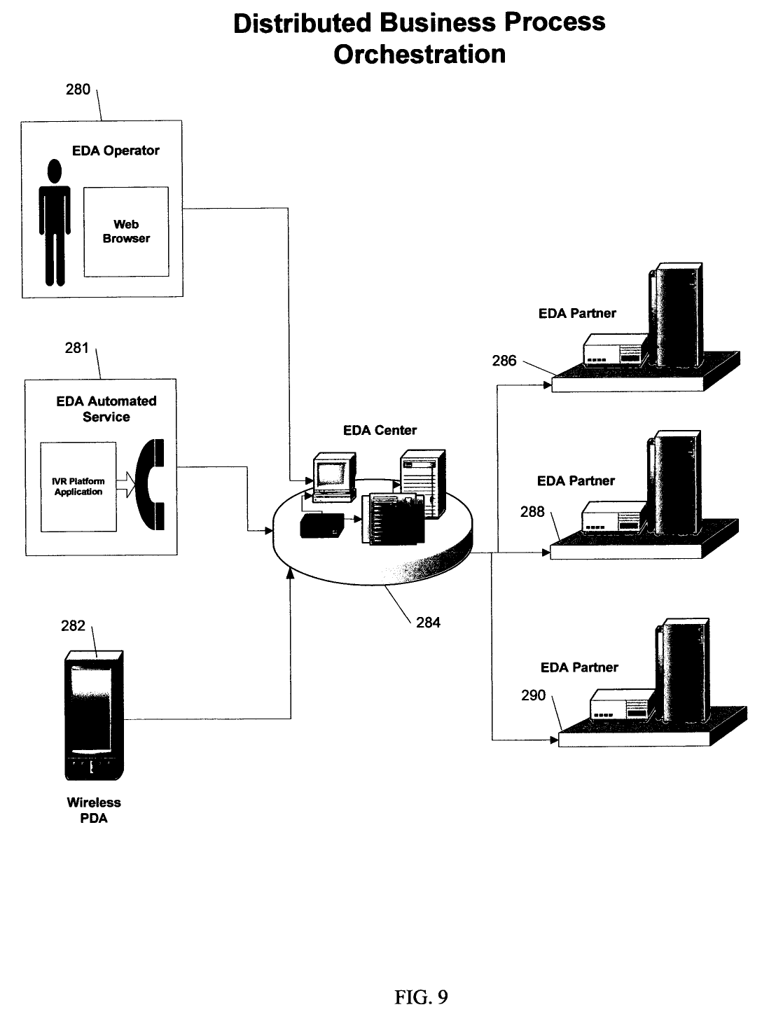

FIG. 9 illustrates how an EDA Center 284 using the disclosed transaction methods and systems can service both multiple delivery platforms from a variety of customers 280, 281 and 282 and multiple complex business processes from a variety of EDA Business Partners 286, 288 and 290.

It is claimed:

1. A method of generating a distributed business transaction in response to a directory assistance request from a telephone customer using a computer network comprising:
maintaining a database including a plurality of directory listings, wherein each listing is associated with a referral phone number, at least one keyword and a bid amount a directory listing owner is willing to pay for a single telephone referral;
receiving a directory assistance request in the form of a keyword from the customer;
identifying the directory listings having keyword terms generating a match with the request;
ordering the identified directory listings into a phone number result list in accordance with the values of the bid amounts for the identified directory listings;
selecting one of the directory listings;
generating a paid referral business transaction and associating it with the listing owner's advertising account;
generating one or a plurality of derivative business transactions to execute the business processes involved in the referral transaction.

2. A system and method for processing a distributed business transaction in response to a directory assistance request from a telephone customer using a computer network comprising:
encapsulating the business transaction parameters in a separate transaction container that can be passed as a complete package to disparately located business transactions;
sending the transaction container to one or a plurality of business processes;
after executing the business process, including the resulting system state as the transaction context for the particular business process;
adding successive transaction contexts to the transaction container in such a way that the sequence of initial state, desired operation, input parameters and resulting state fully describes each step of the multi-step distributed transaction.
